(19) United States
(12) Patent Application Publication
(10) Pub. No.: US 2026/0196648 A1
(43) Pub. Date: Jul. 9, 2026

(54) SECONDARY BATTERY AND BATTERY PACK INCLUDING SECONDARY BATTERY

(71) Applicant: SAMSUNG SDI CO., LTD., Yongin-si (KR)

(72) Inventors: Kwang Soo SEO, Suwon-si (KR); Dae Kyu KIM, Suwon-si (KR); Jong Jun PARK, Suwon-si (KR); Shin Jung KIM, Suwon-si (KR)

(21) Appl. No.: 19/408,662

(22) Filed: Dec. 4, 2025

(30) Foreign Application Priority Data
Jan. 3, 2025 (KR) 10-2025-0000998

(51) Int. Cl. H01M 50/342; H01M 50/213; H01M 50/533; H01M 50/536; H01M 10/0525

(52) U.S. Cl. CPC H01M 50/3425; H01M 50/213; H01M 50/533; H01M 50/536; H01M 10/0525

(57) ABSTRACT

The present disclosure relates to a secondary battery and a battery pack including the the secondary battery. The present disclosure provides a secondary battery including a case forming an opening, an electrode assembly disposed within the case and including an electrode tab, a cap plate disposed in the opening, and a safety vent disposed between the cap plate and the electrode assembly, the safety vent connected to the electrode tab.

### CROSS-REFERENCE TO RELATED APPLICATION

The present application claims priority to and the benefit of Korean Application No. 10-2025-0000998, filed on January 3, 2025, in the Korean Intellectual Property Office, the entire disclosure of which is incorporated by reference herein.

### BACKGROUND

### Field

The present disclosure relates to a secondary battery and a battery pack including the secondary battery.

### Description of the Related Art

Generally speaking, the demand for secondary batteries with enhanced energy density and capacity has been recently and dramatically increased due to the rapidly increasing demand of electronic apparatuses using batteries, such as portable phones, notebook computers, and electric vehicles. Accordingly, research and development for improving performance of lithium secondary batteries is being actively conducted.

A lithium secondary battery includes a positive electrode and a negative electrode, either of which may include an active material, capable of intercalating and deintercalating lithium ions, and an electrolyte. The lithium secondary battery produces electric energy via oxidation and reduction reactions when lithium ions are intercalated/deintercalated at the positive electrode and/or the negative electrode.

This Background section is for the general understanding of the background of the present disclosure, and therefore, it may contain information that does not constitute related (or prior) art.

### SUMMARY

The present disclosure is directed to a secondary battery in which a thickness of a safety vent is variously designed such that an electrode tab is directly connected to the safety vent, which is rupturable by a working pressure. The present disclosure is also directed to a battery pack including the the secondary battery.

Embodiments of the present disclosure provide a secondary battery including a case having an opening, an electrode assembly disposed inside the case and including an electrode tab, a cap plate disposed in the opening, and a safety vent disposed between the cap plate and the electrode assembly and electrically connected to the electrode tab.

Embodiments of the present disclosure provide a secondary battery including a case forming an opening, an electrode assembly disposed within the case and including an electrode tab, a cap plate disposed in the opening, and a safety vent disposed between the cap plate and the electrode assembly, the safety vent electrically connected to the electrode tab.

In some embodiments, the safety vent may include a vent plate, which is disposed to be spaced apart from the cap plate and to which the electrode tab is welded to form a welding portion, and a vent coupling part extending from the vent plate and coupled to the cap plate.

In some embodiments, the safety vent includes: a vent plate spaced apart from the cap plate, the vent plate welded to the electrode tab forming a welding portion; and a vent coupling part extending from the vent plate and coupled to the cap plate.

In some embodiments, a thickness of the vent plate may be different from a thickness of the vent coupling part.

In some embodiments, the thickness of the vent plate may be greater than the thickness of the vent coupling part.

In some embodiments, a welding depth of the welding portion may be about 70% of a thickness of the vent plate.

In some embodiments, the vent plate may be deformed to be bent toward the cap plate by a working pressure.

In some embodiments, the vent plate is configured to be bent toward the cap plate via a working pressure.

In some embodiments, the vent plate may include a first portion to which the electrode tab is welded and a second portion to which the electrode tab is not welded.

In some embodiments, the vent plate includes: a first portion having the electrode tab welded to the vent plate; and a second portion having the electrode tab not welded to the vent plate.

In some embodiments, a thickness of the first portion may be greater than a thickness of the vent coupling part.

In some embodiments, the thickness of the vent coupling part may be about 1/2 to about 4/5 of the thickness of the first portion.

In some embodiments, a thickness of the second portion may be less than a thickness of the vent coupling part.

In some embodiments, the thickness of the second portion may be about 1/2 to about 4/5 of the thickness of the vent coupling part.

In some embodiments, a thickness of the first portion may be different from a thickness of the second portion.

In some embodiments, the thickness of the first portion may be greater than the thickness of the second portion.

In some embodiments, the second portion may be disposed between the first portion and the vent coupling part.

In some embodiments, the first portion may be disposed between the second portion and the vent coupling part.

In some embodiments, the electrode tab may include a first electrode tab and a second electrode tab which have different polarities.

In some embodiments, the electrode tab includes a first electrode tab and a second electrode tab, and wherein the first electrode tab and the second electrode tab have different polarities.

In some embodiments, the first electrode tab may be welded to the first portion.

In some embodiments, the first electrode tab may include a first tab part and a second tab part apart from the first tab part.

In some embodiments, the safety vent includes a notch.

Embodiments of the present disclosure provide a battery pack including a housing and a plurality of secondary batteries disposed in the housing, wherein each of the secondary batteries includes a case having an opening, an electrode assembly disposed inside the case and including an electrode tab, a cap plate disposed in the opening, and a safety vent disposed between the cap plate and the electrode assembly and electrically connected to the electrode tab.

Embodiments of the present disclosure provide a battery pack including a housing and a plurality of secondary batteries disposed in the housing, wherein each of the plurality of secondary batteries includes a case forming an opening, an electrode assembly disposed within the case and including an electrode tab, a cap plate disposed in the opening, and a safety vent disposed between the cap plate and the electrode assembly, the safety vent electrically connected to the electrode tab.

### BRIEF DESCRIPTION OF THE DRAWINGS

The drawings illustrate embodiments of the present disclosure, and further describe aspects and features of the present disclosure along with the detailed description of the present disclosure. Thus, the present disclosure should not be construed as being limited to the drawings:

FIG. 1 is a perspective view illustrating a secondary battery according to embodiments of the present disclosure;

FIG. 2 is a cross-sectional view illustrating the secondary battery according to embodiments of the present disclosure;

FIG. 3 is a schematic view illustrating a cap assembly according to embodiments of the present disclosure;

FIG. 4 is an enlarged view illustrating a welding portion according to embodiments of the present disclosure;

FIG. 5 is a schematic view illustrating a cap assembly according to embodiments of the present disclosure;

FIG. 6 is a schematic view illustrating a cap assembly according to embodiments of the present disclosure;

FIG. 7 is a schematic cross-sectional view illustrating a secondary battery according to embodiments of the present disclosure;

FIG. 8 is a schematic view illustrating a cap assembly according to embodiments of the present disclosure;

FIG. 9 is a schematic view illustrating a modified action of a safety vent according to embodiments of the present disclosure; and

FIG. 10 is a perspective view illustrating a battery pack according to embodiments of the present disclosure.

### DETAILED DESCRIPTION

Hereinafter, exemplary embodiments of the present invention will be described in detail with reference to the accompanying drawings. Terms and words used in the present specification and claims should not be interpreted as being limited to commonly used meanings or meanings in dictionaries and should be interpreted as having meanings and concepts which are consistent with the technological scope of the present invention based on the principle that the inventors have appropriately defined concepts of the terms in order to describe the present invention in the best way.

The embodiments described in this specification and components illustrated in the drawings are only some of the embodiments and do not represent the overall technological scope of the present invention, it should be understood that there may be various equivalents or modifications replacing the exemplary embodiments at the time of filing of this application.

In addition, the terms “comprise,” “include,” “comprising,” and/or “including” used in the present specification specify the presence of stated shapes, numbers, steps, operations, members, elements, and/or groups thereof but do not preclude the presence or addition of one or more other shapes, numbers, steps, operations, members, elements, and/or groups thereof. In addition, when the embodiments of the present invention are described, the terms “may” or “may be” may include “one or more embodiments of the present invention.”

In addition, in order to facilitate understanding of the present invention, the accompanying drawings are not drawn to actual scale, and the dimensions of some components may be exaggerated. In addition, like reference numerals may be assigned to like elements in different embodiments.

The statement that “two comparative objects are the same” means “the two comparative objects are substantially the same.” Therefore, the term “substantially the same” includes a case in which there is a deviation considered as a low level in the art, for example, a deviation of 5% or less. In addition, the description “some parameters are uniform within a certain region” may mean that “some parameters are uniform from an average perspective.”

Although terms such as “first,” “second,” or the like may be used for describing various elements, the elements are not limited by these terms. These terms are only used to distinguish one element from another element, and unless otherwise specifically described, a first element may also be a second element.

Throughout the specification, unless specifically described otherwise, each element may be singular or plural.

A case in which a first element is disposed “over (or under)” or “above (or below)” a second element may include a case in which the first element is disposed in contact with an upper (or lower) surface of the second element or a case in which a third element is interposed between the first element and the second element disposed over (or under) the first element.

When a first element is referred to as being “connected,” “coupled,” or “bonded” to a second element, although the first element may be directly connected or bonded to the second element, it should be understood that a third element may be interposed therebetween, or the first and second elements may be connected, coupled, or bonded through the third element. In addition, when a first part is referred to as being “electrically connected” to a second part, it includes not only a case in which the first part is “directly connected” to the second part but also a case in which the first part is “connected” to the second part with a third element interposed therebetween.

Throughout the specification, unless otherwise specifically described, “A and/or B” means A, B, or A and B. Unless otherwise specifically described, “C to D” means more than or equal to C and less than or equal to D.

When the phrase “at least one of A, B, and C,” “at least one of A, B, or C,” “at least one selected from the group consisting of A, B, and C,” or “at least one selected from A, B, and C” is used to indicate a list of elements A, B and C, the phrase may refer to any suitable combination thereof.

The term “use” may be considered synonymous with the term “utilize.” As used in the present specification, the terms “substantially,” “about,” and words similar thereto are used as terms of approximation rather than terms of degree, and are intended to consider intrinsic variations in measured or calculated values recognized by those skilled in the art.

Although the terms “first,” “second,” “third,” etc. may be used in the present specification to describe various elements, components, regions, layers, and/or sections, these elements, components, regions, layers, and/or sections should not be limited by these terms. These terms are only used to distinguish one element, component, region, layer, or section from another element, component, region, layer, or section. Accordingly, a first member, component, region, layer, or section could be named a second element, component, region, layer, or section without departing from the teachings of the exemplary embodiments.

The spatially relative terms “beneath,” “below,” “lower,” “above,” “upper,” etc., may be used to describe relationships between one component or feature and another component(s) or feature(s) illustrated in the drawings. A spatially relative location may be understood to encompass different orientations of devices, which are being used or operated, in addition to orientations illustrated in the drawings. For example, when a device in the drawing is flipped over, an element described as “under” or “below” another element is understood to be “over” or “above” the other element. Accordingly, the term “below” encompasses both “above” and “below.”

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Terms used in the specification are used to describe embodiments of the present disclosure and are not intended to limit the present disclosure.

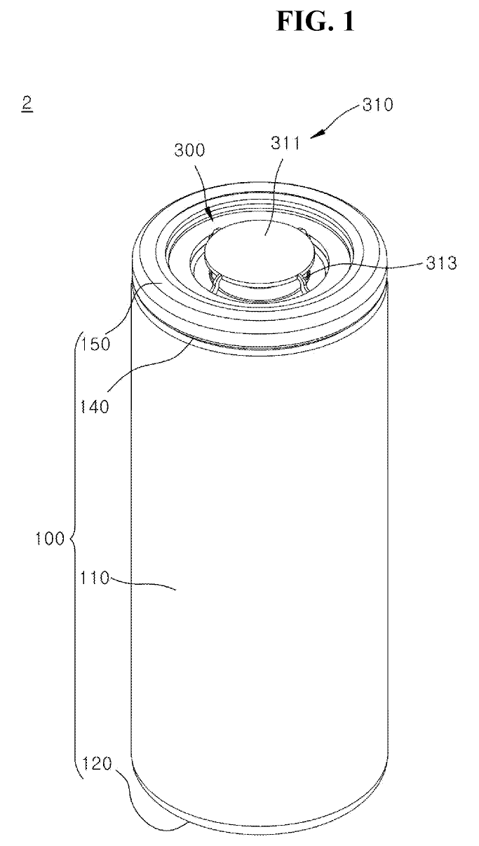

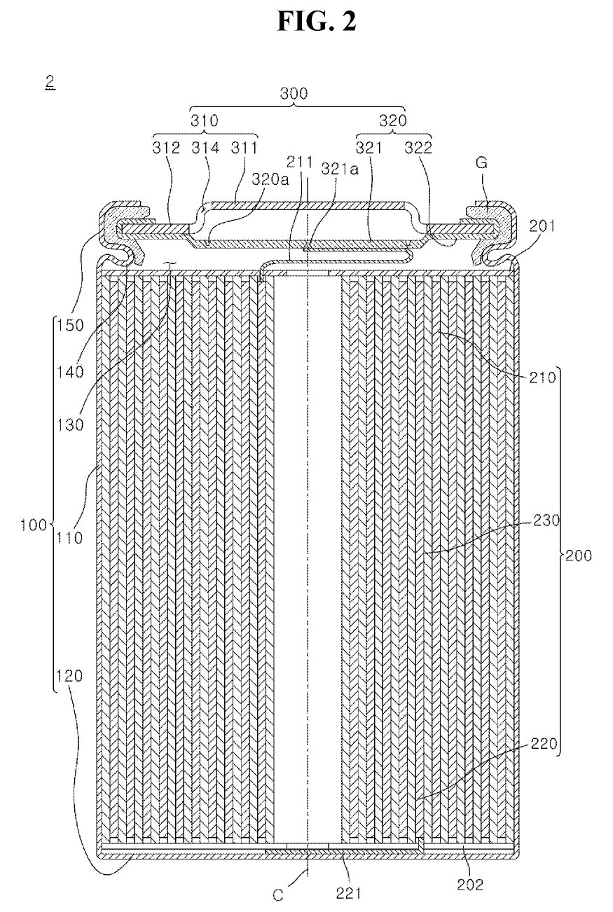

FIG. 1 is a perspective view illustrating a secondary battery according to embodiments of the present disclosure, and FIG. 2 is a cross-sectional view illustrating the secondary battery according to embodiments of the present disclosure.

Referring to FIGS. 1 and 2, a secondary battery 2 may include a case 100, an electrode assembly 200, and a cap assembly 300.

A cylindrical lithium-ion secondary battery 2 is described as the secondary battery 2. However, the present disclosure is not limited thereto, and the secondary battery 2 may have different geometries such as being a lithium polymer battery or a prismatic battery.

The case 100 may form an overall exterior of the secondary battery 2. The case 100 may be electrically conductive. For example, the case 100 may include steel, stainless steel, aluminum, or an aluminum alloy. The case 100 may protect the electrode assembly 200 from external impact. The case 100 may radiate heat to the external environment generated from repeated charging and discharging of the electrode assembly 200 .

The case 100 may include a sidewall portion 110 having a cylindrical geometry. A central axis C of the case 100 may be equivalent to a central axis C of the sidewall portion 110. Both ends of the sidewall portion 110 perpendicular to the central axis C of the case 100 may have an open configuration.

The case 100 may include a bottom portion 120 closing a lower end portion of the sidewall portion 110. The bottom portion 120 may have substantially a disc-like geometry. The bottom portion 120 may face the lower end portion of the sidewall portion 110.

The bottom portion 120 may be disposed perpendicular to the central axis C of the case 100. A circumferential surface of the bottom portion 120 may be coupled to the lower end portion of the sidewall portion 110.

The bottom portion 120 may form a single piece along with the sidewall portion 110. The bottom portion 120 may be manufactured separately from the sidewall portion 110 then coupled to the sidewall portion 110 via welding or the like.

The case 100 may include an opening 130 opening an upper end portion of the sidewall portion 110.

The opening 130 may provide a path through which the electrode assembly 200 is inserted into the case 100 from an upper end region of the case 100. The opening 130 may provide a space in which the cap assembly 300 may be installed.

The opening 130 may include an empty space surrounded by a region of the upper end portion of the sidewall portion 110 located at a side opposite to the bottom portion 120.

The case 100 may include a beading portion 140.

The beading portion 140 may protrude toward the interior of the case 100. The beading portion 140 may restrict the cap assembly 300 from being introduced into the case 100 by a predetermined distance. The beading portion 140 may prevent the electrode assembly 200 from being separated from the case 100.

The beading portion 140 may be disposed on the upper end portion of the sidewall portion 110. A central portion of the beading portion 140 may be concave toward the central axis C of the case 100.

The beading portion 140 may form in a single piece along with the sidewall portion 110. The beading portion 140 may be formed separately from the sidewall portion 110 then coupled to the sidewall portion 110.

The secondary battery 2 may include the beading portion 140, but the present invention is not limited thereto, and the secondary battery 2 may be formed without the beading portion 140.

An inner portion of the case 100 may be filled with an electrolyte. The electrolyte may be injected into the case 100 through the opening 130 of the case 100.

The electrode assembly 200 may function as a unit structure performing charging and discharging operations in the secondary battery 2.

The electrode assembly 200 may include a first electrode 210, a second electrode 220, and a separator 230. The separator 230 may be disposed between the first electrode 210 and the second electrode 220.

The electrode assembly 200 may be disposed inside the case 100. The electrode assembly 200 may be inserted into the case 100 through the opening 130 of the case 100.

The electrode assembly 200 may have a cylindrical geometry in which a wound hole is formed in a central portion. In some embodiments, the electrode assembly 200 may be wound clockwise or counter-clockwise about the wound hole such that the first electrode 210, the separator 230, and the second electrode 220 form a stacked configuration. Accordingly, the electrode assembly 200 may substantially have a jelly roll geometry.

A central axis of the wound hole may be coaxially disposed with the central axis C of the case 100. A cross-sectional geometry of the electrode assembly 200 may have various geometries such as an elliptical geometry or a polygonal geometry in addition to a circular geometry.

The first electrode 210, the separator 230, and the second electrode 220 may be sequentially and concentrically disposed from the wound hole of the electrode assembly 200 in a radial direction.

Both end portions of each of the first electrode 210, the second electrode 220, and the separator 230, all of which are parallel to the central axis C of the case 100, may face the bottom portion 120 and the opening 130 of the case 100.

The first electrode 210 may function as a positive electrode of the electrode assembly 200. The first electrode 210 may be in the form of a foil including a metal material such as aluminum or an aluminum alloy.

A type, a size, and a shape of the first electrode 210 are not specifically limited as long as the first electrode 210 has conductivity without causing detrimental chemical change to the secondary battery 2.

The first electrode 210 may be electrically connected to the cap assembly 300. As the first electrode 210 functions as the positive electrode of the electrode assembly 200, the cap assembly 300 may function as a positive electrode terminal of the secondary battery 2.

The first electrode 210 may be electrically connected to the cap assembly 300 via a first electrode tab 211.

The first electrode tab 211 may include a conductive metal material such as copper, a copper alloy, nickel, or a nickel alloy.

The first electrode tab 211 may be disposed on the electrode assembly 200. Both end portions of the first electrode tab 211 may be connected to the first electrode 210 and the cap assembly 300.

One end portion of the first electrode tab 211 may be directly connected to the first electrode 210. One end portion of the first electrode tab 211 may be indirectly connected to the first electrode 210 through a current collecting plate (not shown) connected to the first electrode 210.

A portion of the first electrode 210 may be coated with a first active material layer. Both surfaces of the first electrode 210 may be coated with the first active material layer. Alternatively, only one surface of the first electrode 210 may be coated with the first active material layer.

As the first electrode 210 functions as the positive electrode, the first active material layer may include a positive electrode active material.

The positive electrode active material may be a reversible intercalation and deintercalation compound for lithium (i.e., a lithiated intercalation compound). The positive electrode active material may include compound oxides of a metal including cobalt, manganese, nickel, iron, or a combination thereof. Lithium may be used as the positive electrode active material.

For example, the positive electrode active material may include lithium-iron-phosphorus oxide (LiFePO4, LFP), lithium-manganese-iron-phosphorus oxide (LiMnFePO4, LMFP), or lithium-nickel-cobalt-manganese oxide (LiNixCoyMnzO2, LNCM). Here, 0<x<1, 0<y<1, 0<z<1, and x+y+z=1.

The positive electrode active material may include only one of lithium-iron-phosphorus oxide (LiFePO₄, LFP), lithium-manganese-iron-phosphorus oxide (LiMnFePO₄, LMFP), or lithium-nickel-cobalt-manganese oxide (LiNiₓCo_{y}Mn_{z}O₂, LNCM). The positive electrode active material may include may include two or all of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, LNCM).

The first active material layer may include a positive electrode conductive material.

The positive electrode conductive material ensures conductivity to the positive electrode active material layer. Any material that does not cause a detrimental chemical change and is electronically conductive may be used as the positive electrode conductive material.

Non-limiting examples of the positive electrode conductive material may include a carbon-based material such as natural graphite, artificial graphite, carbon black, acetylene black, Ketjen black, carbon fiber, carbon nanofibers, carbon nanotubes, a metal-based material in the form of a metal powder or metal fiber containing copper, nickel, aluminum, silver, or the like, a conductive polymer such as a polyphenylene derivative, or a mixture thereof.

The first active material layer may include a positive electrode binder.

The positive electrode binder bonds particles constituting the positive electrode active material to one another. The positive electrode binder attaches the positive electrode active material to the first electrode 210.

A non-aqueous binder, an aqueous binder, a dry binder, or a combination thereof may be used as a non-limiting example of the positive electrode binder.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include styrene-butadiene rubber, (meth)acrylated styrene-butadiene rubber, (meth)acrylonitrile-butadiene rubber, (meth)acrylic rubber, butyl rubber, fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When the aqueous binder is used as the positive electrode binder, the first active material layer may include a cellulose compound which provides viscosity. One or more of carboxymethyl cellulose, hydroxypropyl methyl cellulose, methyl cellulose, and alkaline metal salts thereof may be mixed and used as the cellulose compound. Na, K, or Li may be used as an alkaline metal.

The dry binder is a fibrous polymer material, and may include polytetrafluoroethylene, polyvinylidene fluoride, a polyvinylidene fluoride-hexafluoropropylene copolymer, polyethylene oxide, or a combination thereof.

The second electrode 220 may function as a negative electrode of the electrode assembly 200. The second electrode 220 may be in the form of a foil including a metal material such as copper, a copper alloy, nickel, or a nickel alloy. The second electrode 220 may be disposed to be spaced at a predetermined distance from the first electrode 210 to face the first electrode 210.

The second electrode 220 may be electrically connected to the case 100. The second electrode 220 may be electrically connected to the case 100 via a second electrode tab 221.

As the second electrode 220 functions as the negative electrode of the electrode assembly 200, the case 100 may function as a negative electrode terminal of the secondary battery 2.

The second electrode tab 221 may include a conductive metal material such as copper, a copper alloy, nickel, or a nickel alloy.

The second electrode tab 221 may be disposed under the electrode assembly 200. Both end portions of the second electrode tab 221 may be connected to the second electrode 220 and the bottom portion 120 of the case 100.

One end portion of the second electrode tab 221 may be directly connected to the second electrode 220. One end portion of the second electrode tab 221 may be indirectly connected to the second electrode 220 through a current collecting plate (not shown) connected to the second electrode 220.

A type, a size, and a shape of the second electrode 220 are not specifically limited as long as the second electrode 220 has conductivity without causing a detrimental chemical change to the secondary battery 2.

A portion of the second electrode 220 may be coated with a second active material layer. Both surfaces of the second electrode 220 may be coated with the second active material layer. Alternatively, only one surface of the second electrode 220 may be coated with the second active material layer.

As the second electrode 220 functions as the negative electrode, the second active material layer may include a negative electrode active material.

The negative electrode active material may include a material into which lithium ions may be reversibly intercalated and/or from which lithium ions may be reversibly deintercalated. The negative electrode active material may include a lithium metal, a lithium metal alloy, a material which may be doped in and undoped from lithium, or a transition metal oxide.

The material into which lithium ions may be reversibly intercalated and/or from which lithium ions may be reversibly deintercalated may include a carbon-based negative electrode active material such as crystalline carbon, amorphous carbon, or a combination thereof. Non-limiting examples of the crystalline carbon may include graphite such as natural graphite or artificial graphite in amorphous, platy, flake, spherical, or fibrous form. Non-limiting examples of the amorphous carbon may include soft or hard carbon, mesophase pitch carbide, fired coke, or the like.

The lithium metal alloy may include Na, K, Rb, Cs, Fr, Be, Mg, Ca, Sr, Si, Sb, Pb, In, Zn, Ba, Ra, Ge, Al, or Sn.

The material which may be doped in and undoped from lithium may include a Si-based negative electrode active material or a Sn-based negative electrode active material. The Si-based negative electrode active material may include silicon, a silicon-carbon composite, SiOₓ (x=1 or 2), a Si-Q alloy (Q is selected from the group consisting of alkaline metals, alkaline earth metals, Group 13 elements, Group 14 elements (excluding Si), Group 15 elements, Group 16 elements, transition metals, rare earth elements, and combinations thereof), or a combination thereof. The Sn-based negative electrode active material may include Sn, SnO₂, a Sn-based alloy, or a combination thereof.

The silicon-carbon composite may include a composite of silicon and amorphous carbon. The silicon-carbon composite may include silicon particles coated with amorphous carbon. For example, the silicon-carbon composite may include secondary particles (cores) in which silicon primary particles are assembled and an amorphous carbon coating layer (shell) located on the surface of the secondary particles.

The amorphous carbon may be located between the silicon primary particles so that, for example, the silicon primary particles may be coated with the amorphous carbon. The secondary particles may be dispersed and present in an amorphous carbon matrix.

The silicon-carbon composite may include crystalline carbon. For example, the silicon-carbon composite may include a core including crystalline carbon and silicon particles and an amorphous carbon coating layer located on the surface of the core.

The Si-based negative electrode active material or the Sn-based negative electrode active material may be used in combination with the carbon-based negative electrode active material.

The second active material layer may include a negative electrode conductive material and a negative electrode binder.

The negative electrode conductive material ensures conductivity to the second active material layer. Any material that does not cause a detrimental chemical change and is electronically conductive may be used as the negative electrode conductive material.

Non-limiting examples of the negative electrode conductive material may include a carbon-based material such as natural graphite, artificial graphite, carbon black, acetylene black, Ketjen black, carbon fiber, carbon nanofibers, carbon nanotubes, a metal-based material in the form of a metal powder or metal fiber containing copper, nickel, aluminum, silver, or the like, a conductive polymer such as a polyphenylene derivative, or a mixture thereof.

The negative electrode binder attaches particles constituting the negative electrode active material to one another. The negative electrode binder attaches the negative electrode active material to the second electrode 220.

A non-aqueous binder, an aqueous binder, a dry binder, or a combination thereof may be used as a non-limiting example of the negative electrode binder.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include styrene-butadiene rubber, (meth)acrylated styrene-butadiene rubber, (meth)acrylonitrile-butadiene rubber, (meth)acrylic rubber, butyl rubber, fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When the aqueous binder is used as the negative electrode binder, the first active material layer may include a cellulose compound providing viscosity. One or more of carboxymethyl cellulose, hydroxypropyl methyl cellulose, methyl cellulose, and alkaline metal salts thereof may be mixed and used as the cellulose compound. Na, K, or Li may be used as an alkaline metal.

The dry binder is a polymer material capable of being fiberized, and may include polytetrafluoroethylene, polyvinylidene fluoride, a polyvinylidene fluoride-hexafluoropropylene copolymer, polyethylene oxide, or a combination thereof.

The separator 230 may be disposed between the first electrode 210 and the second electrode 220. The separator 230 may allow lithium ions to migrate between the first electrode 210 and the second electrode 220. The separator 230 may prevent a short circuit between the first electrode 210 and the second electrode 220.

The separator 230 may include polyethylene, polypropylene, polyvinylidene fluoride, or a multilayer film with two or more layers thereof. The separator 230 may include a mixed multilayer membrane such as a two-layer separator with polyethylene/polypropylene, a three-layer separator with polyethylene/polypropylene/polyethylene, or a three-layer separator with polypropylene/polyethylene/polypropylene.

The separator 230 may include a porous substrate and a coating layer which is located on one surface or both surfaces of the porous substrate. The separator 230 may include an organic material, an inorganic material, or a combination thereof.

The porous substrate may include polyolefins such as polyethylene and polypropylene, polyesters such as polyethylene terephthalate and polybutylene terephthalate, polyacetal, polyamide, polyimide, polycarbonate, polyetherketone, polyaryl etherketone, polyetherimide, polyamideimide, polybenzimidazole, polyethersulfone, polyphenylene oxide, cyclic olefin copolymers, polyphenylene sulfide, polyethylene naphthalate, glass fiber, Teflon, and polytetrafluoroethylene, or a polymer film including copolymers or a mixture of two or more thereof.

The organic material may include a polyvinylidene fluoride-based polymer or a (meth)acrylic-based polymer.

The inorganic material may include particles of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto.

The organic material and the inorganic material may be present as a mixture in one coating layer. The organic material and the inorganic material may be present in a form in which a coating layer including an organic material and a coating layer including an inorganic material are stacked.

A first insulating plate 201 and a second insulating plate 202 may be disposed at both sides of the electrode assembly 200. The first insulating plate 201 and the second insulating plate 202 may include an insulation material such as rubber, polyethylene (PE), polypropylene (PP), or polyethylene terephthalate (PET).

The first insulating plate 201 may have substantially a disc geometry. The first insulating plate 201 may be disposed between an upper surface of the electrode assembly 200 and the cap assembly 300. The first insulating plate 201 may prevent the upper surface of the electrode assembly 200 from being in direct contact with the cap assembly 300. The first insulating plate 201 may insulate the electrode assembly 200 from the cap assembly 300.

A through hole (not shown) through which the first electrode tab 211 may pass may be formed in the first insulating plate 201.

The second insulating plate 202 may have substantially a disc geometry. The second insulating plate 202 may be disposed between a lower surface of the electrode assembly 200 and the bottom portion 120 of the case 100. The second insulating plate 202 may prevent the lower surface of the electrode assembly 200 from being in direct contact with the bottom portion 120 of the case 100. The second insulating plate 202 may insulate the electrode assembly 200 from the bottom portion 120 of the case 100.

A through hole (not shown) through which the second electrode tab 221 may pass may be formed in the second insulating plate 202.

The cap assembly 300 may be coupled to the case 100 and face the electrode assembly 200. The cap assembly may seal the case 100. For example, the cap assembly 300 may be disposed on the upper end portion of the sidewall portion 110, that is, at the opening 130.

The cap assembly 300 may be disposed to face the electrode assembly 200 in a direction parallel to the central axis C of the case 100.

The cap assembly 300 may be electrically connected to the first electrode 210 through the first electrode tab 211. As the first electrode 210 functions as the positive electrode of the electrode assembly 200, the cap assembly 300 may function as the positive electrode terminal of the secondary battery 2.

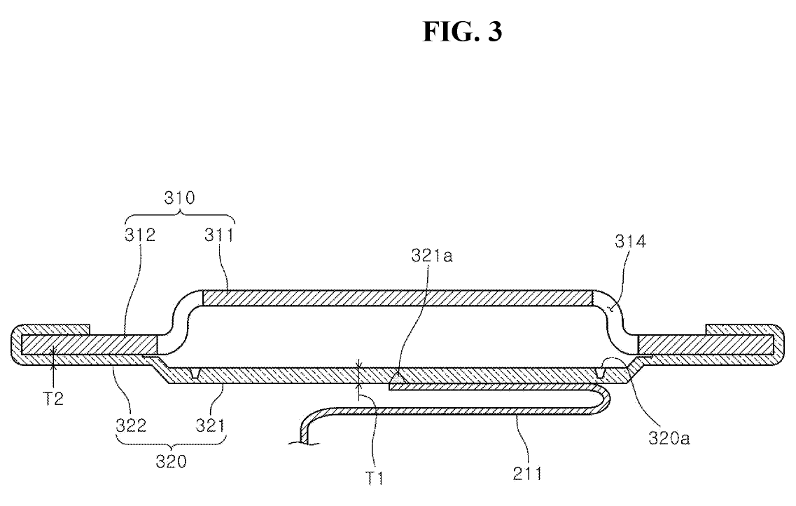

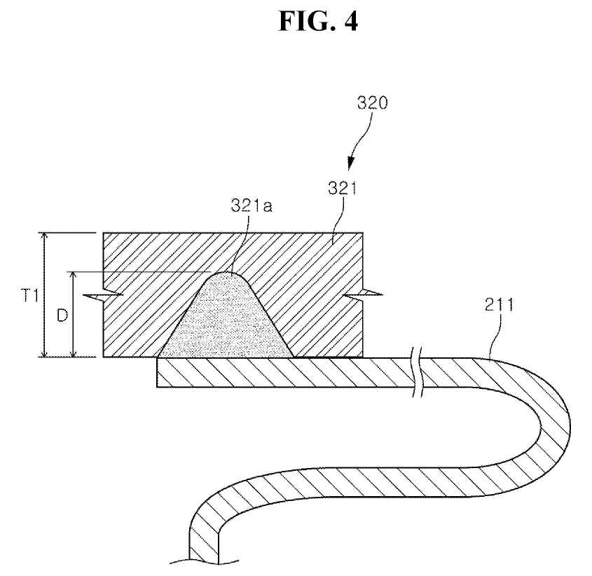

FIG. 3 is a schematic view illustrating the cap assembly according to embodiments of the present disclosure, and FIG. 4 is an enlarged view illustrating a welding portion according to embodiments of the present disclosure.

Referring to FIGS. 1 to 4, the cap assembly 300 may include a cap plate 310 and a safety vent 320.

The cap plate 310 may correspond to an upper exterior of the cap assembly 300. The cap plate 310 may be electrically connected to the first electrode 210 via the safety vent 320.

A central axis of the cap plate 310 may be coaxially located with the central axis C of the case 100. A central portion of the cap plate 310 may protrude in the external direction from the case 100.

The cap plate 310 may include an electrically conductive material such as nickel, aluminum, or copper.

The cap plate 310 may include a small diameter portion 311, a large diameter portion 312, and a bridge 313.

The small diameter portion 311 and the large diameter portion 312 may have disc geometries of varying diameter. The diameter of the small diameter portion 311 may be less than the diameter of the large diameter portion 312.

Central axes of the small diameter portion 311 and the large diameter portion 312 may be coaxial to the central axis C of the case 100. The small diameter portion 311 and the large diameter portion 312 may face each other in a direction of the central axis C of the case 100. The small diameter portion 311 may be disposed above the large diameter portion 312.

The small diameter portion 311 may protrude in the external direction from the case 100. The large diameter portion 312 may be formed in a ring shape having a hollow space formed in a central portion of the large diameter portion 312.

The bridge 313 may be disposed between the small diameter portion 311 and the large diameter portion 312. Both end portions of the bridge 313 may be connected to an outer circumferential surface of the small diameter portion 311 and an inner circumferential surface of the large diameter portion 312.

The bridge 313 may have a curved geometry extending from the small diameter portion 311 toward the large diameter portion 312.

A cap plate hole 314 may be formed in the cap plate 310. The cap plate hole 314 discharges gas and the like generated in the case 100 to the exterior of the case 100.

The cap plate hole 314 may have a hole passing through the bridge 313 of the cap plate 310.

A plurality of cap plate holes 314 may exist. The plurality of cap plate holes 314 may be disposed along a circumferential surface of the central portion of the cap plate 310.

The safety vent 320 may be disposed between the cap plate 310 and the electrode assembly 200. The safety vent 320 may be disposed to face the electrode assembly 200. The safety vent 320 may be electrically connected to the electrode assembly 200. An end portion of the first electrode tab 211 extending from the first electrode 210 may be connected to a lower surface of the safety vent 320.

The safety vent 320 may provide a current flow path between the cap plate 310 and the electrode assembly 200 during normal operation of the secondary battery 2.

The safety vent 320 may include an electrically conductive material such as nickel, aluminum, or copper.

The safety vent 320 may be deformed by gas generated in the case 100 electrically disconnecting the cap plate 310 from the electrode assembly 200 when an over current is generated.

When an internal pressure of the case 100 reaches or exceeds a predetermined level, the safety vent 320 may be ruptured opening a discharge path for the gas between the cap plate hole 314 and the opening 130 of the case 100.

The safety vent 320 may include a vent plate 321 and a vent coupling part 322.

The vent plate 321 may have substantially a disc geometry. The vent plate 321 may be spaced apart from the cap plate 310. The first electrode tab 211 may be welded to the vent plate 321. The end portion of the first electrode tab 211 may be welded to a lower surface of the vent plate 321.

The vent plate 321 may include a welding portion 321a. The first electrode tab 211 is welded to the vent plate 321 via the welding portion 321a.

A welding depth D of the welding portion 321a may be about 70% of a thickness T1 of the vent plate 321. When the welding depth D of the welding portion 321a is less than or greater than about 70% of the thickness T1 of the vent plate 321, leakage may occur due to cracks that may have formed when the first electrode tab 211 is welded to the vent plate 321.

The vent coupling part 322 may extend from the vent plate 321. The vent coupling part 322 may extend in a radial direction of the vent plate 321. The vent coupling part 322 may be coupled to the cap plate 310.

The vent coupling part 322 may support the vent plate 321 against the cap plate 310. The vent coupling part 322 may provide electrical connection between the cap plate 310 and the vent plate 321.

The vent coupling part 322 may include the same material as the vent plate 321. The vent coupling part 322 may form a single piece along with the vent plate 321. Alternatively, the vent plate 321 may be manufactured separately and then coupled to the vent plate 321.

A current generated from the first electrode 210 may flow to the cap plate 310 sequentially through the first electrode tab 211, the vent plate 321, and the vent coupling part 322.

The vent coupling part 322 may surround an end portion of the cap plate 310. The vent coupling part 322 may surround an edge region of the large diameter portion 312. For example, the vent coupling part 322 may have substantially a U-shaped crosssection.

One end portion of the vent coupling part 322 may be in contact with an upper surface of the large diameter portion 312. The other end portion of the vent coupling part 322 may be bent downward to be in contact with a lower surface of the large diameter portion 312. The vent coupling part 322 may be coupled to the cap plate 310 by various coupling methods such as laser welding, ultrasonic welding, or resistance welding.

The vent coupling part 322 may face the beading portion 140. For example, the vent coupling part 322 may be disposed above the beading portion 140. During assembly of the secondary battery 2, the beading portion 140 may restrict the cap assembly 300 from being inserted into the case 100 by a predetermined distance.

The vent plate 321 may be deformed to be bent by a working pressure. The working pressure may be a minimum pressure causing the deformation of the vent plate 321.An internal pressure of the case 100 may increase due to a thermal runaway or ignition of the electrode assembly 200 so that emissions such as flames, gas, and smoke generated in the case 100 may pressure the vent plate 321.

When the internal pressure of the case 100 increases, a central portion of the vent plate 321 may be deformed protruding upward forming a convex geometry toward the cap plate 310.

The thickness T1 of the vent plate 321 may be different from a thickness T2 of the vent coupling part 322. For example, the thickness T1 of the vent plate 321 may be greater than the thickness T2 of the vent coupling part 322. The thickness T1 of the vent plate 321 may be greater than or equal to about 30% of the thickness T2 of the vent coupling part 322. Cracks may be prevented when the first electrode tab 211 is welded to the vent plate 321.

The safety vent 320 may include a notch 320a. The notch 320a may be disposed in a connecting portion between the vent plate 321 and the vent coupling part 322 but is not limited thereto.

As the internal pressure of the case 100 increases to or exceeds a predetermined pressure (or a rupturing pressure of the safety vent) due to a thermal runaway or ignition of the electrode assembly 200, the notch 320a may be ruptured.

The case 100 may include a crimping part 150. The crimping part 150 fixes a location of the cap assembly 300 and prevents the cap assembly 300 from being separated from the case 100.

The crimping part 150 may extend from an upper end portion of the beading portion 140. An end portion of the crimping part 150 may be bent toward the central axis of the case 100. An inner surface of the crimping part 150 may surround an outer circumferential surface of the vent coupling part 322.

A gasket G may be disposed between the crimping part 150 and the cap assembly 300. The gasket G may electrically insulate the case 100 from the cap assembly 300 and block moisture or the electrolyte from being introduced or discharged between the case 100 and the cap assembly 300.

The gasket G may include an insulation material such as rubber, PE, PP, or PET.

The gasket G may have substantially a ring geometry. The gasket G may have substantially a U-shaped crosssection. An outer surface of the gasket G may be in close contact with the inner surface of the crimping part 150 and an inner surface of the beading portion 140. An inner surface of the gasket G may surround an outer surface of the vent coupling part 322 and may be in close contact with the outer surface of the vent coupling part 322.

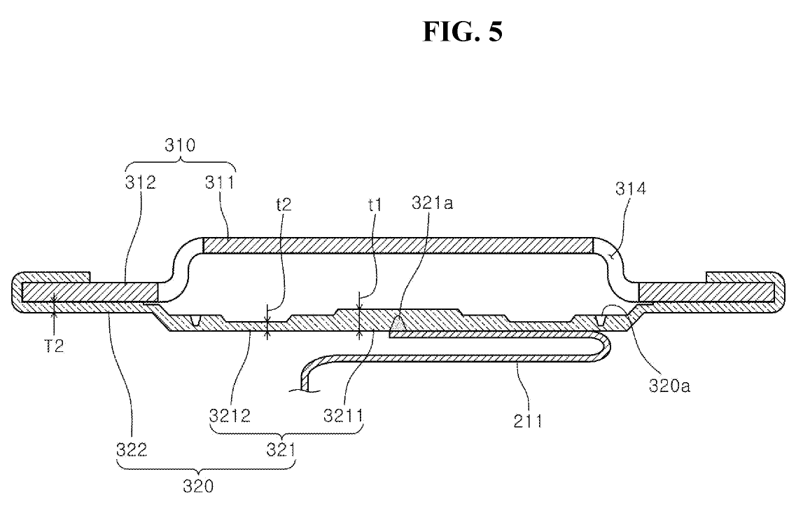

FIG. 5 is a schematic view illustrating a cap assembly according to embodiments of the present disclosure.

Referring to FIG. 5, the vent plate 321 may include a first portion 3211 and a second portion 3212.

A first electrode tab 211 may be welded to the first portion 3211. A central axis of the first portion 3211 may be coaxially disposed with a central axis of a cap plate 310.

A thickness t1 of the first portion 3211 may be different from a thickness T2 of a vent coupling part 322. For example, the thickness t1 of the first portion 3211 may be greater than the thickness T2 of the vent coupling part 322. The thickness T2 of the vent coupling part 322 may be about 1/2 to about 4/5 of the thickness t1 of the first portion 3211.

The first electrode tab 211 may not be welded to the second portion 3212. The second portion 3212 may be disposed between the first portion 3211 and the vent coupling part 322. A thickness t2 of the second portion 3212 may be different from the thickness T2 of the vent coupling part 322. For example, the thickness t2 of the second portion 3212 may be less than the thickness T2 of the vent coupling part 322. More specifically, the thickness t2 of the second portion 3212 may be about 1/2 to about 4/5 of the thickness T2 of the vent coupling part 322.

The thickness t1 of the first portion 3211 may be different from the thickness t2 of the second portion 3212. For example, the thickness t1 of the first portion 3211 may be greater than the thickness t2 of the second portion 3212.

Because the thickness t1 of the first portion 3211 is greater than the thickness t2 of the second portion 3212 and the thickness T2 of the vent coupling part 322, a length of the first electrode tab 211 extending from a first electrode 210 may decrease and welding quality may be improved.

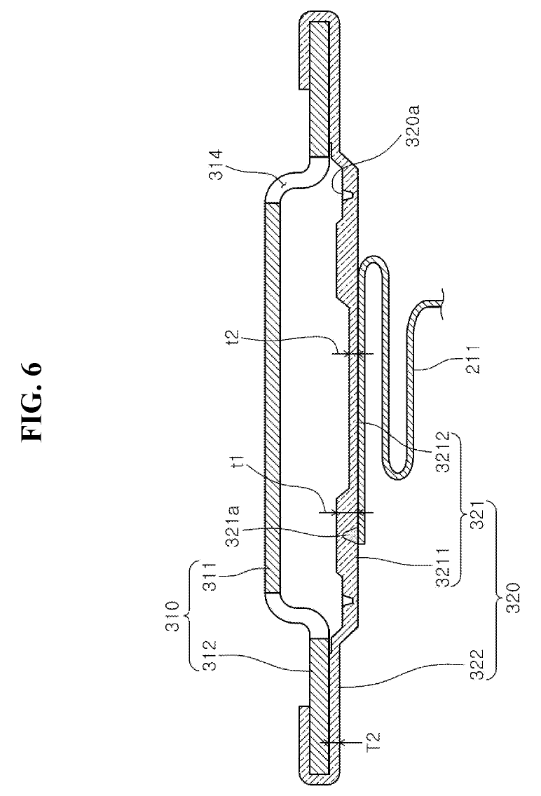

FIG. 6 is a schematic view illustrating a cap assembly according to embodiments of the present disclosure.

Referring to FIG. 6, the vent plate 321 may include a first portion 3211 and a second portion 3212.

A first electrode tab 211 may be welded to the first portion 3211. A thickness t1 of the first portion 3211 may be different from a thickness T2 of the vent coupling part 322. For example, the thickness t1 of the first portion 3211 may be greater than the thickness T2 of the vent coupling part 322. More specifically, the thickness T2 of the vent coupling part 322 may be about 1/2 to about 4/5 of the thickness t1 of the first portion 3211.

The first electrode tab 211 may not be welded to the second portion 3212. A central axis of the second portion 3212 may be coaxially disposed with a central axis of a cap plate 310. The first portion 3211 may be disposed between the second portion 3212 and the vent coupling part 322.

A thickness t2 of the second portion 3212 may be different from the thickness T2 of the vent coupling part 322. For example, the thickness t2 of the second portion 3212 may be less than the thickness T2 of the vent coupling part 322. The thickness t2 of the second portion 3212 may be about 1/2 to about 4/5 of the thickness of the vent coupling part 322.

The thickness t1 of the first portion 3211 may be different from the thickness t2 of the second portion 3212. For example, the thickness t1 of the first portion 3211 may be greater than the thickness t2 of the second portion 3212.

Because the thickness t1 of the first portion 3211 is greater than the thickness t2 of the second portion 3212 and the thickness T2 of the vent coupling part 322, a length of the first electrode tab 211 extending from a first electrode 210 may increase, and welding quality may be improved.

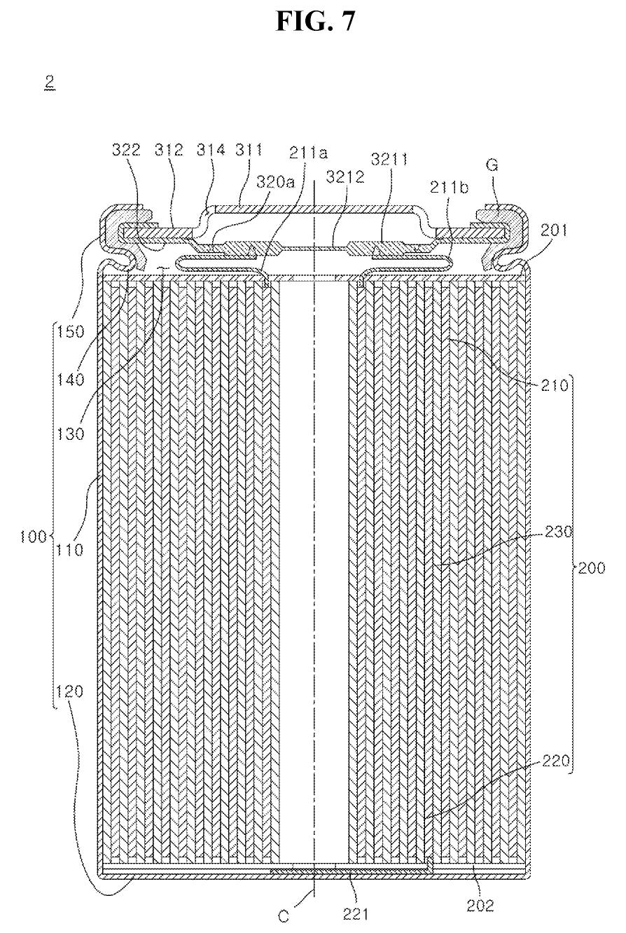

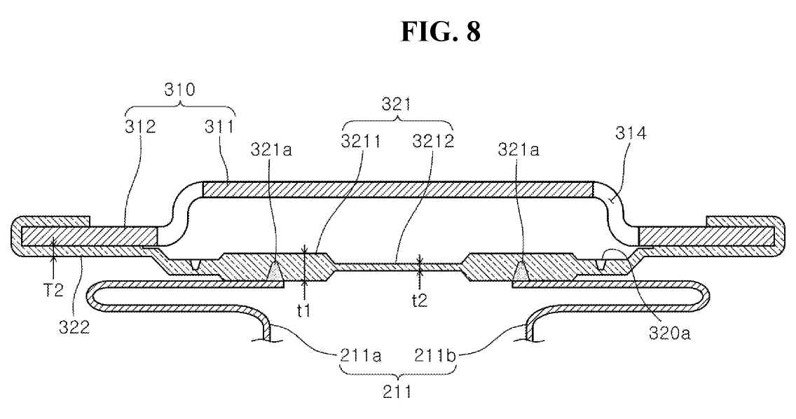

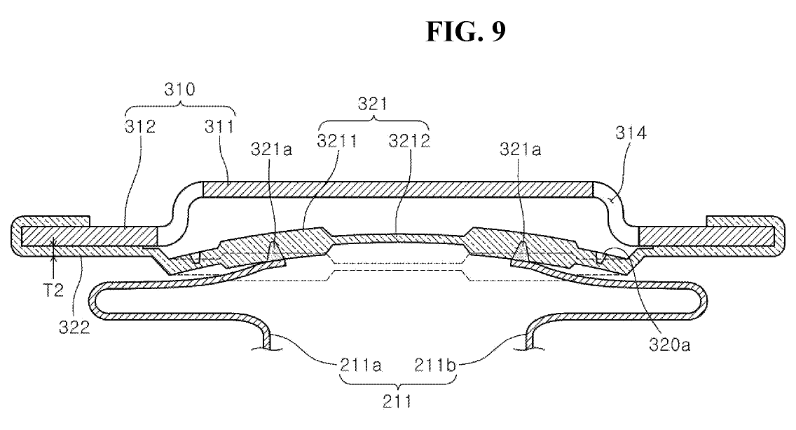

FIG. 7 is a cross-sectional view illustrating the secondary battery according to embodiments of the present disclosure, FIG. 8 is a schematic view illustrating a cap assembly according to embodiments of the present disclosure, and FIG. 9 is a schematic view illustrating a modified action of a safety vent according to embodiments of the present disclosure.

Referring to FIGS. 7 to 9, the vent plate 321 may include a first portion 3211 and a second portion 3212.

The first electrode tab 211 may be welded to the first portion 3211. The first electrode tab 211 may include a first tab part 211a and a second tab part 211b. The first tab part 211a and the second tab part 211b may be spaced apart from each other.

The first tab part 211a may extend from any one first electrode 210 of a plurality of first electrodes 210 constituting an electrode assembly 200 and may be welded to the first portion 3211. The second tab part 211b may extend from one first electrode 210 excluding the first electrode 210 from which the first tab part 211a extends and may be welded to the first portion 3211. The first tab part 211a and the second tab part 211b may be welded to the first portion 3211 to be spaced apart from each other.

A thickness t1 of the first portion 3211 may be different from a thickness T2 of the vent coupling part 322. For example, the thickness t1 of the first portion 3211 may be greater than the thickness T2 of the vent coupling part 322. The thickness T2 of the vent coupling part 322 may be about 1/2 to about 4/5 of the thickness t1 of the first portion 3211.

The first electrode tab 211 may not be welded to the second portion 3212. A central axis of the second portion 3212 may be coaxially disposed with a central axis of a cap plate 310. The first portion 3211 may be disposed between the second portion 3212 of the vent coupling part 322.

A thickness t2 of the second portion 3212 may be different from the thickness T2 of the vent coupling part 322. For example, the thickness t2 of the second portion 3212 may be less than the thickness T2 of the vent coupling part 322. The thickness t2 of the second portion 3212 may be about 1/2 to about 4/5 of the thickness of the vent coupling part 322.

The thickness t1 of the first portion 3211 may be different from the thickness t2 of the second portion 3212. For example, the thickness t1 of the first portion 3211 may be greater than the thickness t2 of the second portion 3212.

Because the thickness t2 of the second portion 3212 disposed in the central portion of the vent plate 321 is less than the thickness t1 of the first portion 3211, when an internal pressure of a case 100 is applied, the central portion of the vent plate 321 protrudes upward to have a convex geometry. The entire vent plate 321 is smoothly curved and deformed to be bent upward toward the cap plate 310 to rupture the notch 320a while a low rupturing pressure may be applied.

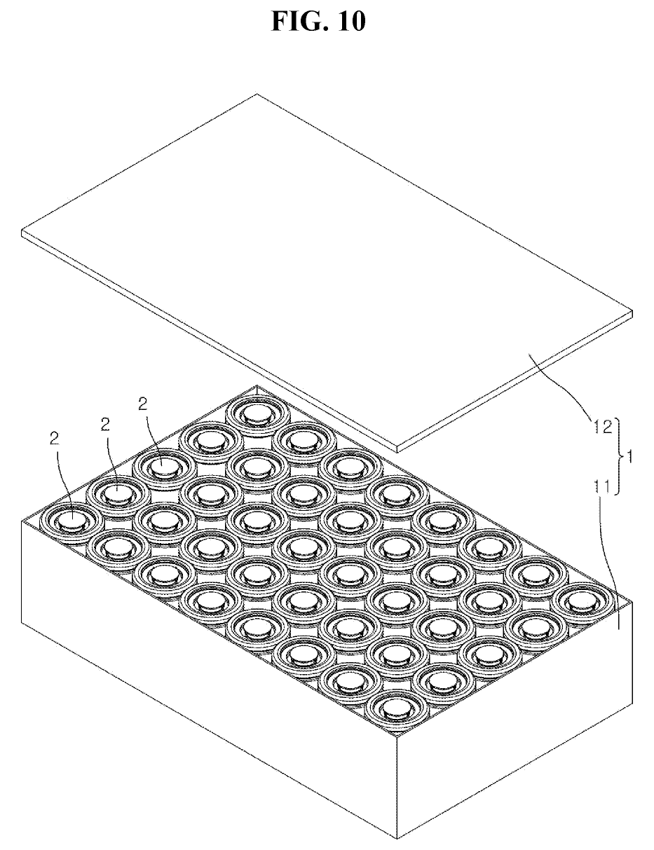

FIG. 10 is a perspective view illustrating a battery pack according to embodiments of the present disclosure.

Referring to FIG. 10, the battery pack includes a housing 1 and a secondary battery 2.

The housing 1 may form an overall exterior of the battery pack and provide a space in which the secondary battery 2 may be accommodated.

The housing 1 may include a housing body 11 and a housing cover 12.

The housing body 11 may have a hollow box geometry having one side open. A cross-sectional geometry of the housing body 11 is not limited to the quadrangular geometry illustrated in FIG. 10 and its design may have various geometries such as a polygonal geometry, a circular geometry, or an elliptical geometry.

The housing cover 12 may be coupled to the housing body 11 and close an inner space of the housing body 11. For example, the housing cover 12 may have substantially a plate geometry and face an open side of the housing body 11.

The housing cover 12 may be fixed to the housing body 11 viavarious coupling methods such as bolting, welding, and fitting.

The secondary battery 2 may be installed in the housing 1. A plurality of secondary batteries 2 may exist. The plurality of secondary batteries 2 may be disposed in the housing 1 in various patterns such as a lattice pattern or a zigzag pattern.

The plurality of secondary batteries 2 may be disposed parallel to each other. The design of the number of secondary batteries 2 may vary according to a size, a shape, and the like of the housing 1.

The plurality of secondary batteries 2 may be electrically connected to each other through a busbar (not shown). The plurality of secondary batteries 2 may be connected in series or in parallel through the busbar. For example, in the housing 1, the busbar may connect the secondary batteries 2 disposed in the same row in parallel and connect the secondary batteries 2 disposed in two adjacent rows in series. The busbar may include an electrically conductive material such as copper, aluminum, or nickel.

A thickness of a safety vent can be variously designed such that an electrode tab is directly connected to a safety vent which can be ruptured by a working pressure.

Because a thickness of a vent plate is greater than that of a vent coupling part, leakage that may occur due to cracks that may have formed when an electrode tab is welded to the vent plate, can be prevented.

However, effects which can be achieved through the present disclosure are not limited to the above-described effects, and other effects which are not described above will be clearly understood by those skilled in the art from the above description of the present disclosure.

Although the present invention has been described with reference to embodiments illustrated in the accompanying drawings, these are merely exemplary. It will be understood by those skilled in the art that various modifications and other equivalent embodiments are possible from the embodiments of the present invention.

What is claimed is:

1. A secondary battery comprising:
a case forming an opening;
an electrode assembly disposed within the case and comprising an electrode tab;
a cap plate disposed in the opening; and
a safety vent disposed between the cap plate and the electrode assembly, the safety vent electrically connected to the electrode tab.

2. The secondary battery of claim 1, wherein the safety vent comprises:
a vent plate spaced apart from the cap plate, the vent plate welded to the electrode tab forming a welding portion; and
a vent coupling part extending from the vent plate and coupled to the cap plate.

3. The secondary battery of claim 2, wherein a thickness of the vent plate is different from a thickness of the vent coupling part.

4. The secondary battery of claim 3, wherein the thickness of the vent plate is greater than the thickness of the vent coupling part.

5. The secondary battery of claim 2, wherein a welding depth of the welding portion is about 70% of a thickness of the vent plate.

6. The secondary battery of claim 2, wherein the vent plate is configured to be bent toward the cap plate via a working pressure.

7. The secondary battery of claim 2, wherein the vent plate comprises:
a first portion having the electrode tab welded to the vent plate; and
a second portion having the electrode tab not welded to the vent plate.

8. The secondary battery of claim 7, wherein a thickness of the first portion is greater than a thickness of the vent coupling part.

9. The secondary battery of claim 8, wherein the thickness of the vent coupling part is about 1/2 to about 4/5 of the thickness of the first portion.

10. The secondary battery of claim 7, wherein a thickness of the second portion is less than a thickness of the vent coupling part.

11. The secondary battery of claim 10, wherein the thickness of the second portion is about 1/2 to about 4/5 of the thickness of the vent coupling part.

12. The secondary battery of claim 7, wherein a thickness of the first portion is different from a thickness of the second portion.

13. The secondary battery of claim 12, wherein the thickness of the first portion is greater than the thickness of the second portion.

14. The secondary battery of claim 13, wherein the second portion is disposed between the first portion and the vent coupling part.

15. The secondary battery of claim 13, wherein the first portion is disposed between the second portion and the vent coupling part.

16. The secondary battery of claim 7, wherein the electrode tab includes a first electrode tab and a second electrode tab, and wherein the first electrode tab and the second electrode tab have different polarities.

17. The secondary battery of claim 16, wherein the first electrode tab is welded to the first portion.

18. The secondary battery of claim 17, wherein the first electrode tab comprises:
a first tab part; and
a second tab part spaced apart from the first tab part.

19. The secondary battery of claim 1, wherein the safety vent comprises a notch.

20. A battery pack comprising:
a housing; and
a plurality of secondary batteries disposed inside the housing,
wherein each of the plurality of secondary batteries comprises:
a case forming an opening;
an electrode assembly disposed within the case and comprising an electrode tab;
a cap plate disposed in the opening; and
a safety vent disposed between the cap plate and the electrode assembly, the safety vent electrically connected to the electrode tab.
